(19) United States
(12) Patent Application Publication
(10) Pub. No.: US 2003/0117902 A1
(43) Pub. Date: Jun. 26, 2003

(54) Radio-controlled apparatus and radio-controlled timepiece by using the same

(76) Inventors: Shigeo Suzuki, Chiba-shi (JP); Kenichi Nakajima, Chiba-shi (JP); Yoshimitsu Kurasawa, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/306,693

(22) Filed: Nov. 27, 2002

(30) Foreign Application Priority Data
Nov. 29, 2001 (JP) 2001-364185

(51) Int. Cl. G04C 11/02

(52) U.S. Cl. 368/47

(57) ABSTRACT

To provide a radio-controlled apparatus in which a user can foresee a waiting time of the radio controlled time correction and a radio-controlled timepiece having the apparatus. The radio-controlled apparatus of the radio-controlled timepiece comprises a radio-controlled mechanism for correcting time of the timepiece main body according to the time information included in the standard time radio wave JJY and a display mechanism for displaying a progress state of the radio-controlled time correction by the radio-controlled mechanism.

### BACKGROUND OF THE INVENTION

1. Field of the Invention

The present invention relates to a radio-controlled timepiece, and more particularly to a display of the radio-controlled timepiece.

2. Description of the Prior Art

There is well known a radio-controlled timepiece for correcting time by using a standard time radio wave including time information. In the conventional radio-controlled timepiece having a pointer, the pointer of the timepiece is stopped at zero indicating the twelve o'clock position before receiving the standard time radio wave and a radio-controlled operation (time correction by the standard time radio wave) is performed as the pointer remains at zero.

Since the time information within the standard time radio wave is generally represented by the unit of one minute, the radio-controlled operation requires one minute and more on the whole, and the time varies depending on the timing of issuing an instruction of the radio-controlled time correction (generally, about one to three minutes). Accordingly, a user cannot foresee a required waiting time and he or she may feel some discontent. This disadvantage is often found especially in a wristwatch type in which a user can instruct a radio-controlled time correction at any desired time and hold the watch by hand during the time correction, and the disadvantage, however, is not restricted to the wristwatch type.

### SUMMARY OF THE INVENTION

In consideration to the above point, an object of the invention is to provide a radio-controlled apparatus and a radio-controlled timepiece having the same apparatus in which a user can foresee a waiting time of the radio controlled time correction.

In order to achieve the above object, the radio-controlled apparatus of the invention comprises a radio-controlled mechanism for correcting time of a timepiece main body according to the time information included in a standard time radio wave and display means for displaying a progress state of radio-controlled time correction according to the radio-controlled mechanism.

Since the radio-controlled timepiece of the invention is provided with “display means for displaying the progress state of radio-controlled time correction by the radio-controlled mechanism”, a user can know the progress state of the radio-controlled time correction, according to the display of the display means, and foresee a waiting time of the radio-controlled time correction.

The display means may be designed to display the progress state by using a liquid crystal panel and the like for displaying the pointers (hour pointer, minute pointer, and second pointer) and the like of the timepiece main body or the timepiece display characters (numeric values of hour, minute, and second, and the like) for use in general time display, or it may be designed to display the progress state by a lamp for displaying the progress state or any other state display unit separately provided. In the latter case, the timepiece main body and the radio-controlled apparatus may be separate. Further, when the timepiece main body is provided with a plurality of time display areas, one of them may be designed to be used for displaying the progress state.

The “progress state” of the radio-controlled time correction displayed by the display means may be of any type of the receiving time information, the received time information, and the un-received time information, and it may be of any two types of the above three or all types of the above three.

Further, when displaying the received time information, it may be designed to display the content (for example, “hour”, “minute”, “second”, and the like) as for the received time information.

In order to achieve the above object, the radio-controlled timepiece of the invention comprises the radio-controlled apparatus and a timepiece main body in which a display time is corrected by the radio-controlled apparatus.

### BRIEF DESCRIPTION OF THE SEVERAL VIEWS OF THE DRAWINGS

A preferred form of the present invention is illustrated in the accompanying drawings in which:

FIG. 1 is a block diagram of a radio-controlled timepiece provided with a radio-controlled apparatus according to a preferred embodiment of the invention;

FIG. 2 shows the former half portion of the flow chart of the radio controlled operation (including the display control of the progress state of the radio control time correction) of the preferred embodiment in the radio-controlled timepiece of FIG. 1;

FIG. 3 shows the latter half portion of the flow chart of the radio controlled operation (including the display control of the progress state of the radio control time correction) of the preferred embodiment in the radio-controlled timepiece of FIG. 1;

FIGS. 4 are explanatory views showing the display of the progress state of the radio-controlled time correction according to the radio-controlled timepiece of the preferred embodiment of the invention; and

FIG. 5 is an explanatory view schematically showing the time information pulse included in the standard time radio wave for use in the radio-controlled timepiece of FIG. 1.

### DETAILED DESCRIPTION OF THE PREFERRED EMBODIMENTS

A preferred mode for carrying out the invention will be described according to a preferred embodiment shown in the accompanying drawings.

[Embodiment]

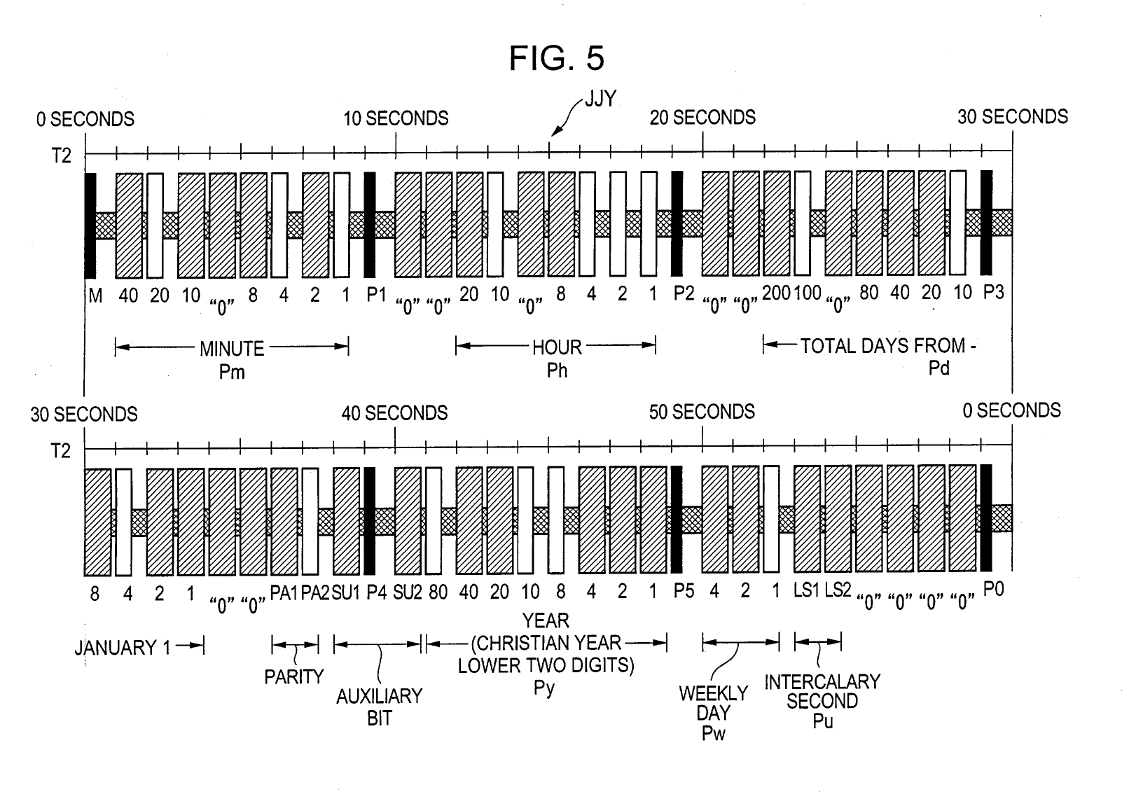

Before description about a radio-controlled timepiece 1 of a preferred embodiment of the invention, the time information CT of a standard time radio wave JJY to be received by a radio-controlled apparatus 2 of the radio-controlled timepiece 1 will be described according to FIG. 5.

In the standard time radio wave JJY, the amplitude of a carrier wave of 40 KHz or 60 KHz is generally pulse-modulated by the time information CT repeated for every one minute. A pulse signal indicating the time information CT includes a marker (pulse) M of narrow width rising up at 00 second in every minute, excluding 15 minute o'clock and 45 minute o'clock in every hour, minute pulse group Pm of BCD (binary coded decimal) codes from 01 to 09 seconds in every minute, hour pulse group Ph of BCD codes from 12 to 19 seconds in every minute, day (the number of days) pulse group Pd of BCD codes from 22 to 29 seconds in every minute and from 30 to 34 seconds in every minute, year pulse group Py of BCD codes from 41 to 49 seconds in every minute, weekly day pulse Pw binary coded from 50 to 53 seconds in every minute, and pulse Pu about the intercalary second from 53 to 55 seconds in every minute, and it includes position markers (pulse) of narrow width P1, P2, P3, P4, P5 or P0 (hereinafter, collectively represented by Pi when they are not distinguished from each other) in every ten seconds. Here, the pulse width or the pulse duration of the respective marker pulses (in the specification, the pulse indicating the so-called marker M and the pulse indicating the position maker Pi are collectively referred to as “marker pulse”) M, P1, P2, P3, P4, P5, and P0 is about 0.2 second. When the code value is “0”, the pulse width of the BCD code pulse is about 0.8 seconds, and when the code value is “1”, it is about 0.5 seconds, and a difference of the pulse width therebetween is plus or minus about 5 mili-second.

Accordingly, by detecting a point where two of a marker pulses M or Pi (i means 0 to 5) of narrow width are continuous, 00 second is detected, and by detecting the marker pulse M or Pi (i means 1 to 5) of narrow width next to the detection of the 00 second, the following minute information pulse Pm, the hour information pulse Ph, the value Pd2 of 3-digit and 2-digit in the day number information pulse Pd and the value Pdl of 1-digit of the pulse Pd, the year information pulse Py, and the weekly day information pulse Pw and the like are distinguished and the content of the respective coded information can be detected. Here, the weekly day data doesn't have to be detected, because it can be calculated from the Christian year (year data) and the total days (the day number data).

In FIG. 5, PA1 and PA2 are parity bits, and SU1 and SU2 are auxiliary information bits. In 15 minutes and 45 minutes o'clock in every hour, a call mark and announcement of stop wave and a notice pulse of the stop wave period are attached there, instead of the year information Py, the weekly day information Pw, and the intercalary second information Pu.

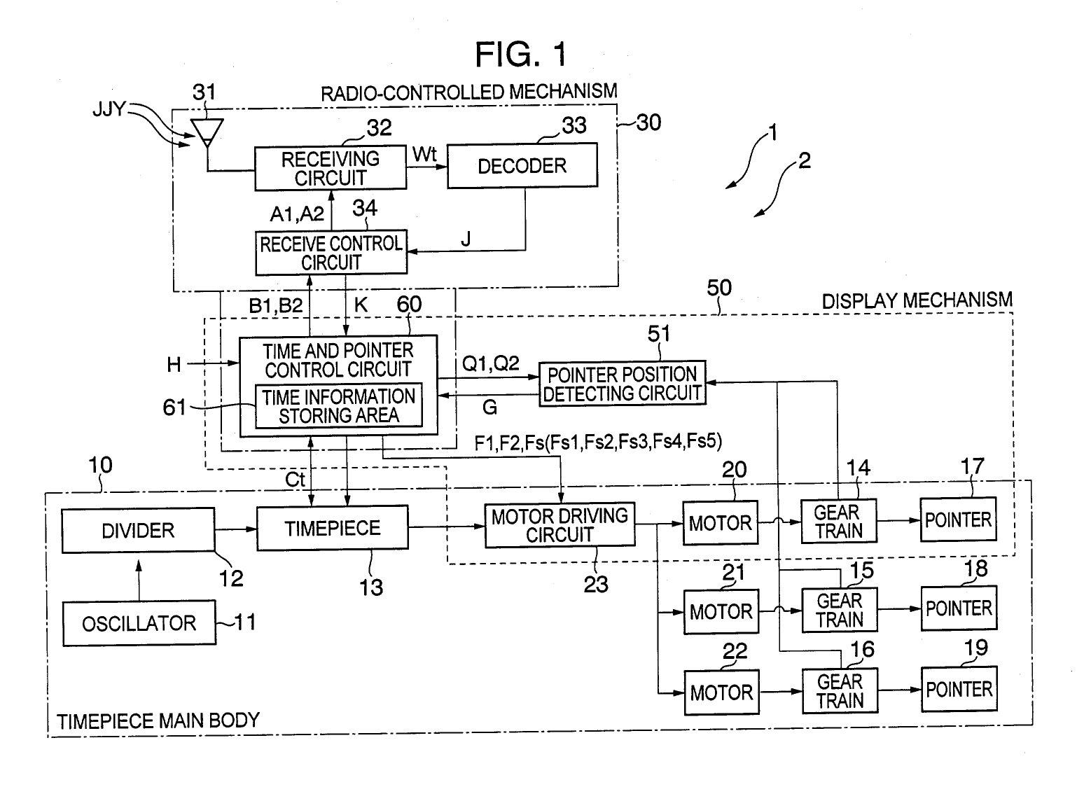

The radio-controlled timepiece 1 for correcting time by using this standard time radio wave JJY comprises a timepiece main body 10 and a radio-controlled apparatus 2, and the radio-controlled apparatus 2 includes a radio-controlled mechanism 30 and a display mechanism 50. In the example shown in FIG. 1, as described below, although some elements of the display mechanism 50 of the radio-controlled apparatus 2 are shared with the timepiece main body 10, if desired, the elements may be separately provided or the whole elements may be separately provided.

The timepiece main body 10 comprises an oscillator 11, a divider 12 for dividing a pulse from the oscillator 11 to create a second pulse and the like, a timepiece 13 for counting and clocking second pluses and the like, and a motor driving circuit 23 for driving motors 20, 21, and 22 for rotating a second pointer 17, a minute pointer 18, and an hour pointer 19 respectively through gear train 14, 15, and 16 according to a timepiece signal of the timepiece 13. Here, for the sake of brief description, assume that the second pointer 17, the minute pointer 18, and the hour pointer 19 can be individually moved to each desired position by the respective motors 20, 21, and 22. In the following example, the second pointer 17 and the corresponding motor 20 and gear train 14 are used in common with the display mechanism 50 together with the motor driving circuit 23.

The radio-controlled mechanism 30 comprises a receiving antenna 31 of the standard time radio wave JJY, a receiving. circuit 32 for receiving the standard time radio wave JJY selectively in cooperation with the receiving antenna 31, then amplifying and demodulating the received signal to take out a pulse signal including the time information CT, shaping the waveform of the pulse signal, and supplying it as a waveform shaped signal Wt, a decoder 33 for time-coding the waveform shaped pulse signal Wt including the time information CT from the receiving circuit 32 and issuing a receive result signal J indicating the pulse width of the signal Wt (for example, a binary signal becoming a high level (or a low level) by the time corresponding to the pulse width), and a receive control circuit 34 for giving a receive start signal A1 or a receive stop signal A2 to the receiving circuit 31 so as to start or stop the reception of the standard time radio wave by the receiving circuit 31 when receiving a receive start control signal B1 or a receive stop control signal B2, receiving the receive result signal J from the decoder 33 to judge a receiving state in the following judging procedure E, and issuing a pointer position operating signal K.

While, the display mechanism 50 includes a time and pointer control circuit 60 for controlling a display and a pointer position detecting circuit 51 for detecting the positions (return-to-zero) of the pointers 17, 18, and 19. The pointer 17, the motor 20 for rotating the pointer 17 through the gear train 14, and the motor driving circuit 23 of the same motor 20 are used in common with the timepiece main body. Alternatively, these elements 14, 17, 20, and 23 maybe provided independently in the displaymechanism 50. The time andpointer control circuit 60 may be regarded as one portion of the radio-controlled mechanism 30, instead of defining as one portion of the display mechanism 50, or it may be regarded as one portion of the both radio-controlled mechanism 30 and the display mechanism 50.

The time and pointer control circuit 60 controls (1) the return-to-zero movement of the pointers 17, 18, and 19 according to a start instruction H of the radio-controlled time correction such as a user's press of the push button switch (not illustrated) or arrival at a specified time for radio-controlled time correction, (2) receiving of the time information CT by the radio-controlled mechanism 30 (receiving of the standard time radio wave JJY and take-out of the time information), and (3) display of the pointers 17, 18, and 19, according to the received signal K from the radio-controlled mechanism 30.

In the return-to-zero control of the time and pointer control circuit 60, the control circuit 60 issues a motor signal F1 for detecting a pointer position to the motor driving circuit 23, in reply to reception of the start signal H of the radio-controlled time correction, so as to drive the motors 20, 21, and 22, and issues a pointer position detection start signal Q1 to the pointer position detecting circuit 51 so as to start the position detection of the pointers 17, 18, and 19. The position detection signal G is received from the pointer position detecting circuit 51, hence to receive a notice to the effect that the pointers 17, 18, and 19 are returned to the initial position (zero), and transmission of the pointer position detecting motor signal F1 to the motor driving circuit 23 is stopped and a position detection stop signal Q2 is issued to the pointer position detecting circuit 51 so to stop the detection of the pointer position. The return-to-zero control is generally performed by the respective pointers 17, 18, and 19 in parallel.

In the receiving control of the time and pointer control circuit 60, the control circuit 60 issues the receive start control signal B1 to the receive control circuit 34 of the radio-controlled mechanism 30 in reply to the reception of the return-to-zero position detection signal G from the pointer position detecting circuit 51, and when a predetermined hour has passed after transmission of the receive start control signal B1 because of completion of the reception or failure of the reception, the receive stop control signal B2 is issued to the receive control circuit 34 so as to stop the reception of the standard time radio wave JJY by the receiving circuit 32.

In the display control of the time and pointer control circuit 60, the control circuit 60 issues a state display motor signal Fs to the motor driving circuit 23 in reply to the reception of the pointer position operating signal K from the receive control circuit 34 so as to move the pointer 17 to a specified position. The state display motor signal Fs includes a motor signal Fs1 of minute data receive success accompanying the success in receiving the minute data, a motor signal Fs2 of hour data receive success accompanying the success in receiving the hour data, a motor signal Fs3. of day data receive success accompanying the success in receiving the day data, and a motor signal Fs4 of year data receive success accompanying the success in receiving the year data. These state display motor signals Fs1, Fs2, Fs3, and Fs4 may be signals of individually different types. Or they may be designed in that how many times state display motor signal is counted by the motor driving circuit 23 and that a predetermined driving signal is given to the motor 20 depending on the count value.

In the display control of the time and pointer control circuit 60, in case of succeeding in reception and completing the reception of the standard time radio wave JJY, the correct time information CTm is written into the timepiece 13 based on the received time information CT so as to correct the content, and a motor signal F2 for returning the time is given to the motor driving circuit 23 so as to adjust the display time by the pointer 17 and the like to the radio-controlled correct time. When failing in the reception and issuing the receive stop control signal B2, the non-corrected current time information Ct is read out from the timepiece 13 and the time returning motor signal F2 is given to the motor driving circuit 23 so as to adjust the display time by the pointer 17 and the like to the non-corrected time.

Since the power consumption becomes greater in the receiving processing and the pointer position detecting processing, the processing operations can be restrained to the minimum. An optical signal, a magnetic signal, contact points or a limit switch or the like may be used for detecting the pointer position.

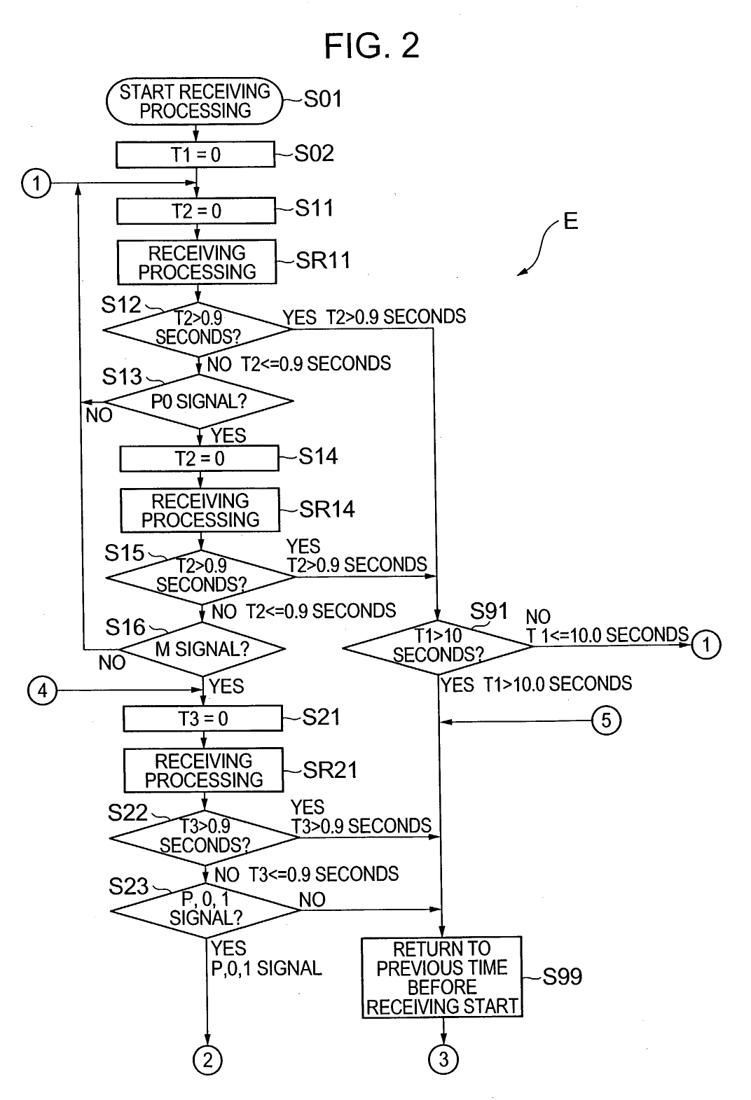

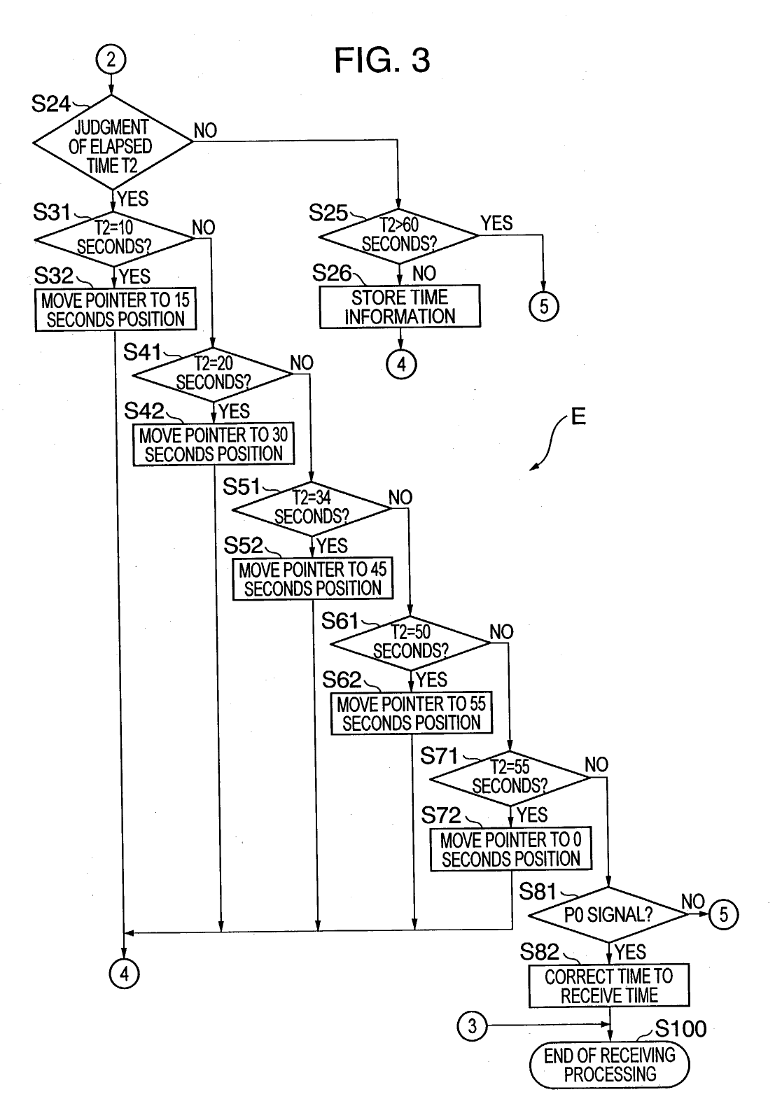

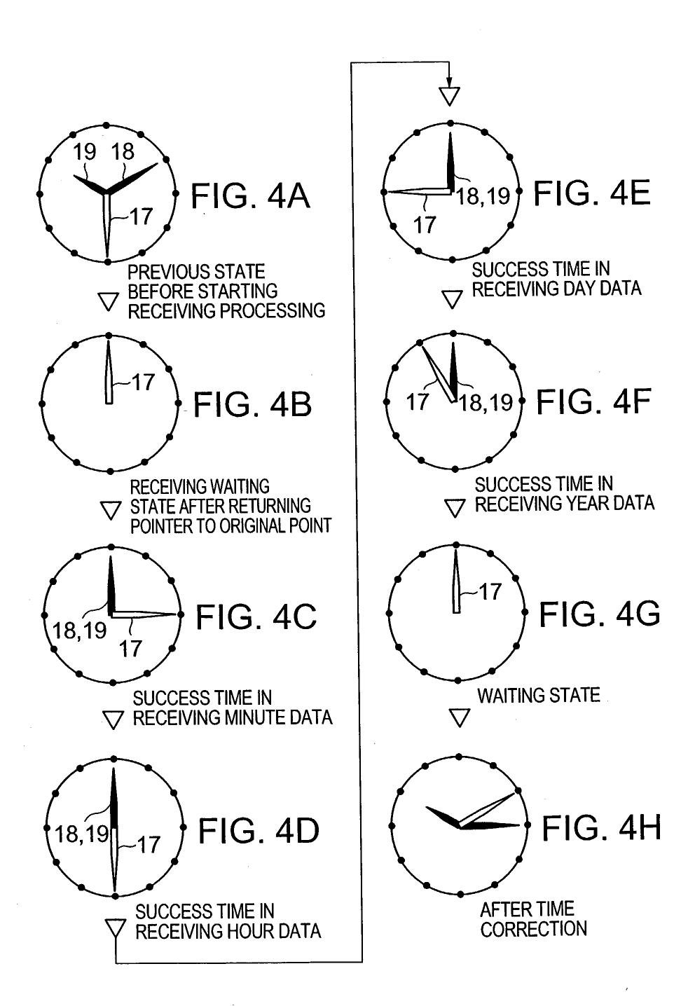

The operation of the radio-controlled timepiece 1 of the preferred embodiment according to the invention constituted as mentioned above will be described in details, according to the flow charts of FIG. 2 and FIG. 3 and the flow of display of FIG. 4, in addition to FIG. 1 and FIG. 5.

Prior to the radio-controlled time correction, as illustrated in FIG. 4(a), the pointer 17 of the display mechanism 50 of the radio-control clock 1 displays the ordinal time display as the second pointer of the timepiece 1, together with the minute pointer 18 and the hour pointer 19 of the timepiece main body 10.

For example, when a user pushes a push button switch (not illustrated) in order to do the radio-controlled time correction and instructs the radio-controlled time correction, the start signal H of the radio-controlled time correction is given to the time and pointer control circuit 60 and the time and pointer control circuit 60 controls the return-to-zero operation as mentioned above. Namely, the time and pointer control circuit 60 issues the pointer position detecting motor signal F1 to the motor driving circuit 23 so as to drive the motors 20, 21, and 22 to start to move the pointer 17 to the zero position (the twelve o'clock position on the dial plate in the example of FIG. 4). Simultaneously, the start signal Q1 of the pointer position detection is issued to the pointer position detecting circuit 51 so as to start the position detection of the pointer 17. When the pointer 17 reaches the initial position (zero position), the return-to-zero position detection signal G is given from the pointer position detecting circuit 51 to the time and pointer control circuit 60, the time and pointer control circuit 60 stops transmission of the pointer position detecting motor signal F1 to the motor driving circuit 23 so as to stop the movement of the pointer 17 and issues the position detection stop signal Q2 to the pointer position detecting circuit 51 so as to stop the detection of the pointer position. Although the description as mentioned above has been made as if only the second pointer 17 for use in describing the progress state of the radio-controlled time correction was returned to zero, generally the pointers 18 and 19 other than the second pointer 17 are returned to zero, similarly to the second pointer 17, as illustrated in FIG. 4(b) indicating the state where the return-to-zero operation has been completed. When performing the return-to-zero control on all the pointers 17, 18 and 19, all the pointers 17, 18, and 19 are controlled to be returned to zero independently (in parallel). When the positions of the respective pointers 18 and 19 can be always detected and the respective pointers 18 and 19 can be moved quickly, the pointers 18 and 19 not used for displaying the progress state of the radio-controlled time correction may be left, for example, at the original positions.

Upon completion of the predetermined return-to-zero control, when receiving the return-to-zero position detection signal G as for all the pointers 17, 18, and 19 that are the targets for return-to-zero operation, from the pointer position detecting circuit 51, the receive start control signal B1 is sent from the time and pointer control circuit 60 to the receive control circuit 34, so as to start a receive control shown in the flow charts of FIG. 2 and FIG. 3 (Step S01 in FIG. 2). In the receive control of the receive control circuit 34, the time parameter T1 for checking the standard time radio wave receive is reset (Step S02 in FIG. 2). While, when the receive start signal A1 is supplied from the receive control circuit 34 having received the receive start control signal B1, to the receiving circuit 32, the receiving processing of the standard time radio wave JJY by the receiving circuit 32 is started (Step SR11). When detecting the rising up of the pulse signal Wt wave-shaped in the receiving processing SR1, the parameter T2 for checking the receiving processing time is reset (Step S11).

In the receiving processing (Step SR11), as mentioned above, the standard time radio wave JJY is selectively received by the receiving circuit 32 in cooperation with the receiving antenna 31 of the radio-controlled mechanism 30, amplified and detected, and a pulse signal including the time information CT is taken out, wave-shaped, sent to the decoder 33 as the wave shape signal Wt, time-coded, and then sent to the receive control circuit 34 as the receive result signal J which is kept at a high level by the time corresponding to the pulse width of the signal Wt.

The receiving processing time T2 of the receiving processing is determined as the time for keeping the receive result signal J at a high level, and the pulse width information included in the receive result signal J is obtained according to the receiving processing time T2 (namely, when the receive result signal is an analog binary signal, the time from the rising edge to the lowering edge is counted as the receiving processing time or the pulse width T2, and when it is the digital binary signal, for example, the predetermined pulse width indicating the level 1 and the time of repeated bit signals of a cycle or the repeated number are counted as the receiving processing time or the pulse width T2). Thus, in Step S12, whether or not the receiving processing time T2 is longer than 0.9 seconds is judged.

When the receiving processing time T2 is 0.9 seconds and shorter, the received signal is judged to be the marker pulse M or Pi whose pulse width is about 0.2 seconds, or to be the data pulse whose pulse width is about 0.5 seconds or about 0.8 seconds, and further it is checked whether the receive result signal J indicates the pulse of about 0.2 seconds, namely the marker pulse M or Pi (Step S13). When the receive result signal J doesn't indicate the marker pulse M or Pi, this step is returned to Step S11 again. Namely, loop processing including Steps S11 to S13 will be performed until detecting the marker pulse M or Pi.

When it is found that the receive result signal J indicates the marker pulse M or Pi, the receiving processing time parameter T2 is reset (Step S14) when the receiving processing SR14 of the next wave shape pulse Wt starts (for example, at the rising edge of the receive result signal J), it is judged whether the pulse of the time information CT (the marker pulse M or Pi whose pulse width is about 0.2 seconds or the data pulse whose pulse width is about 0.5 seconds or about 0.8 seconds has been detected from the receiving processing time T2 (Step S15); when it is judged that the pulse of the time information CT has been detected, whether or not the receive result signal J indicates the marker pulse M or Pi is judged according to the pulse width (pulse duration) (Step S16). In case of the receive signal of the standard time radio wave JJY, it is only when the marker M is issued continued from the position marker P0 that the positive judgment of the marker pulse is made again in Step S16 and therefore, the second one of the continuous marker pulses is the marker M at the 00 second. Namely, in case of going through Step S16 with YES, it means that the marker M indicating the 00 second has been detected, and the receiving processing time parameter T2 counts the passage of time thereafter as long as the normal reception is performed. Accordingly, the receiving processing time parameter T2 directly indicates the passage of 00 to 60 seconds after detecting the marker M at the 00 second, and the receiving processing time parameter T2 enables identification of each pulse of the time information CT described by the second in FIG. 5.

While, when the time information pulse CT received in the receiving processing SR14 is not the marker M, this step is returned to Step S11 again, where detection of the marker pulse M or Pi is retried. Accordingly, Steps S11 to S16 correspond to the process for detecting the marker M at the 00 second and deciding the starting point of the receiving processing time T2 on the whole.

When detection of the marker M at the 00 second is finished, the receiving processing SR21 of each pulse is started in order to fully detect the time information CT included in the standard time radio wave JJY and the receiving time judgment parameter T3 is reset (Step S21) at the receiving start point of the pulse (at the rising edge of the receive result signal J or at a transition to the higher level data). When the receiving processing SR21 has been completed at a lowering edge of the receive result signal J or at a transition to the lower level data, it is judged whether the receiving processing time T3 has got excessively longer (Step S22). When the receiving processing time T3 is within a predetermined time (0.9 seconds and shorter in this example), it is further judged whether the time T3 is about 0.2 seconds (marker pulse signal Pi or M), about 0.8 seconds (the value “0”), or about 0.5 seconds (the value “1”) (Step S23), and it is judged whether the passage time T2 after 00 second reaches each division time (for example, 10, 20, 34, 50, and 55 seconds) of finishing each data type Pm, Ph, Pd, Py, and Pu of the time information CT, or whether it reaches the division time (60 seconds) of the time information per every minute (Step S24). How much degree a difference can be permitted as the pulse width of each pulse type, is properly determined in consideration of the concrete situation such as a receiving system.

When the passage time T2 doesn't stand in the division time, like the case it doesn't reach the division time, 10 seconds, it is judged whether it exceeds the whole time of the time information (60 seconds) (Step S25). When it is within the above time, the content of the BCD code value of the receive result signal J is stored in the predetermined time information storing area 61 as one part of the data of the time information CT (Step S26). This step is returned to Step S21, where the receiving processing of the next pulse signal is repeated (Steps SR21 and S21).

According to this, the loop processing including Steps S21 to S26 is performed until about 10 seconds passes after starting the receiving processing, and the BCD code value Cpm of the minute information pulse Pm is stored in the time information storing area 61 of the time and pointer control circuit 60. When the process comes into Step S24 after detecting the position marker p1, since it is judged to reach the 10 seconds, for example, by a reference of rounding up, going through Step S24 with YES, the process goes on to Step S31 of judging the completion of the minute data reception. In this case, since it is YES, the process goes on to Step S32 of operating the pointer 17 according to the completion of the minute data reception.

Namely, when it is judged YES in Step S31 of judging the completion of the minute data reception, the receive control circuit 34 issues the pointer position operating signal K, the time and pointer control circuit 60 having received this signal K sends the first state display motor signal Fs1 to the motor driving circuit 23, so to rotate the motor 20 by the first predetermined amount and move the pointer 17 (the second pointer in this example) to a predetermined position indicating the success in receiving the minute data (at the position of fifteen seconds as illustrated in FIG. 4C in this example) through the gear train 14. This movement of the pointer 17 in order to display the completion of the minute data reception is performed during T2=10 to 12 seconds where the data to be received does not exist substantially. Accordingly, by viewing that the pointer 17 is moving to the three o'clock position or that it stands there, a user can recognize the success in receiving the minute data. In this case, when the reception is performed normally, although it usually takes time in a range of about 11 seconds to 70 seconds (about 130 seconds at the maximum) until coming into the state of FIG. 4C after staring the receiving operation, a user can know the success in receiving the minute data and he or she can know that the reception of the time data and the latter is still left behind, at the point of the passage of at the latest about 70 seconds, namely about 50 seconds prior to the completion of the receiving operation.

Similarly, after repeating storage of the time information Ph (Step S26), when the time, T2=00 to about 20 seconds passed, going through Step S24 again with YES, going through Step S31 with NO, the process comes into Step of judging the time data reception (Step S41), then going through this Step S41 with YES. Namely, it is judged YES in Step S41 of judging the completion of the time data reception, the receive control circuit 34 issues the second pointer position operating signalK, the time and pointer control circuit 60 having received the signal K sends the second state display motor signal Fs2 to the motor driving circuit 23, so to rotate the motor 20 by the second predetermined amount and move the second pointer 17 to a predetermined position indicating the success in receiving the time data (at the position of 30 seconds as illustrated in FIG. 4(d) in this example) through the gear train 14 (Step S42). This movement of the pointer 17 in order to display the completion of the time data reception is performed during T2=about 20 to 22 seconds where the data to be received does not exist substantially.

Similarly, when T2 indicates the passage of 34 seconds, going through from Step S24 to Step S31 and Step S41 with NO, the process comes into Step S51, then going through this Step S51 with YES. At this time, in reply to the judgment of YES in Step S51 of judging the completion of the day data reception, the receive control circuit 34 issues the third pointer position operating signal K, and the time and pointer control circuit 60 having received the signal K sends the third state display motor signal Fs3 to the motor driving circuit 23, so to rotate the motor 20 by the third predetermined amount and move the second pointer 17 to a predetermined position indicating the success in receiving the day data (at the position of 45 seconds as illustrated in FIG. 4(e) in this example) through the gear train 14 (Step S52). This movement of the pointer 17 in order to display the completion of the day (total days) data reception is performed during T2=about 34 to 36 seconds.

Similarly, when T2 indicates the passage of 50 seconds, going through Steps S24, S31, S41, and S51 with NO, the process comes into Step S61, then going through this Step S61 with YES. At this time, in reply to the YES judgment in Step S61 of judging the completion of the year data reception, the receive control circuit 34 issues the fourth pointer position operating signal K, and the time and pointer control circuit 60 having received this signal K sends the fourth state display motor signal Fs4 to the motor driving circuit 23, so to rotate the motor 20 by the fourth predetermined amount and move the second pointer 17 to a predetermined position indicating the success in receiving the year data (at the position of 55 seconds as illustrated in FIG. 4(f) in this example) through the gear train 14 (Step S62). This movement of the pointer 17 in order to display the completion of the Christian year data reception is performed during T2=about 50 to 52 seconds.

Similarly, when T2 indicates the passage of 55 seconds, going through Steps S24, S31, S41, S51, and S61 with NO, the process comes into Step S71, then going through this Step S71 with YES. At this time, in reply to the YES judgment in Step S71 of judging the completion of the intercalary second data reception, the receive control circuit 34 issues the fifth pointer position operating signal K, and the time and pointer control circuit 60 having received this signal K sends the fifth state display motor signal Fs5 to the motor driving circuit 23, so to rotate the motor 20 by the fifth predetermined amount and move the second pointer 17 to a predetermined position indicating the success in receiving the intercalary second data (at the position of 60 seconds or 00 second as illustrated in FIG. 4(g) in order to indicate the completion of the reception of all the data, in this example) through the gear train 14 (Step S72). This movement of the pointer 17 in order to display the completion of the reception of all the data is performed during 55 to 59 seconds.

During the above processing, the receive time information (minute, hour, day, year, presence of intercalary second) is stored and obtained, and for example, the radio-controlled correct time data CTm with one minute added to these obtained time information is held in the time and pointer control circuit 60.

At last, similarly, when T2 indicates the passage of 60 seconds, going through Steps S24, S31, S41, S51, S61, and S71 with NO, the process comes into Step S81, then going through this Step S81 with YES. At this time, in reply to the YES judgment in Step S81 of judging the position marker Pi (actually P0), the receive control circuit 34 issues the time correction instruction to the time and pointer control circuit 60, and the time and pointer control circuit 60 writes the radio-controlled correct time data CTm into the timepiece 13 and gives the time returning motor signal F2 to the motor driving circuit 23. As a result, the minute pointer 18 and the hour pointer 19 are moved to the radio-controlled correct position, according to the radio-controlled correct time data CTm stored in the timepiece 13 (Step S82). Upon completion of the movement, counting by the timepiece 13, and the movement of the pointers 17, 18, 19, and the like accordingly are resumed actually at the 00 second (in Step S100 and in FIG. 4(h)).

When failing in receiving the time information pulse CT, the timepiece is returned to the time (previous time before receiving start) continued to be counted by the timepiece 13 previous to the receiving start (Step S99). In this Step S99, the time information Ct is read from the timepiece 13 and the time returning motor signal F2 is given to the motor driving circuit 23 so to display the time corresponding to the time information Ct, thereby-finishing the radio-controlled time correction (Step Sl00). Even in case of failing in receiving once, it may be designed to repeat several trials of receiving, and only in case of failing in receiving finally, it may be designed to perform the above Steps S99 and S100.

The receiving processing fails in the following cases: when the detection of the P0 signal is not performed even after 60 seconds and more has passed since detection of the marker M (in case of YES judgment in Step S25), when the detected pulse at a time of 60 seconds elapse after detection of the marker M is not the marker pulse (P0) (the case of NO judgment in Step S81), when the pulse detected after detection of the marker M is not the position marker Pi nor the pulse indicating the value “0” or “1” (the case of NO judgment in Step S23), when the pulse width T3 of the pulse received after detection of the marker M exceeds 0.9 seconds (the case of YES judgment in Step S22), and when the pulse width of the received pulse exceeds 0.9 seconds even if ten seconds and more has elapsed after starting the receiving processing (Step S01) (the case of YES judgment in Step S91 after going through Step S12 and Step S15 with YES).

The above-mentioned procedure E shown in FIG. 2 and FIG. 3 may be changed depending on a desire as far as the processing intended by the invention can be performed.

Although the progress state of the radio-controlled time correction is represented by the position of the second pointer iT) the above embodiment, it may be represented by the minute pointer or the hour pointer, instead of the second pointer, alternatively by two or three of the second, minute and hour pointers.

Alternatively, instead of corresponding the progress state of the radio-controlled time correction with the specified positions of the pointer, for example, as shown in FIGS. 4, the minute pointer, the hour pointer, and the like may be sequentially moved to the position corresponding to the receive time, every time receiving of the time information CT of the standard time radio wave JJY has been completed as for one part of data such as minute and hour. In this case, it is not necessary to return the pointer to zero before receiving start, but in case of a little amendment, it is preferable to return the pointer to zero before the receiving start because a view of the progress state of time correction is difficult.

Further, in case of a timepiece having a plurality of (for example, two) time display areas such as dial plate, the time before the radio-controlled time correction is continuously displayed on one time display area, while the pointer of the other time display area may be moved according to the progress of the radio-controlled time correction, so as to display the progress state of the radio-controlled time correction on the other time display area.

For example, FIG. 4C indicating the success in receiving the minute data may be regarded as in the un-received state of the hour data, the day date, the year data and the like.

What is claimed is

1. A radio-controlled apparatus comprising:
a radio-controlled mechanism for correcting time of a timepiece main body according to time information included in a standard time radio wave; and
a display for displaying a progress state of radio-controlled time correction by the radio-controlled mechanism.

2. The radio-controlled apparatus as claimed in claim 1, wherein the display is designed to display the type of the time information under receiving.

3. The radio-controlled apparatus as claimed in claim 1, wherein the display is designed to display the type of the time information having been received.

4. The radio-controlled apparatus as claimed in claim 3, wherein the display is designed to display the content of the time information having been received.

5. The radio-controlled apparatus as claimed in claim 1, wherein the display is designed to display the type of the time information un-received.

6. A radio-controlled timepiece comprising:
a radio-controlled apparatus as claimed in claim 1; and
a timepiece main body in which a display time is corrected by the apparatus.
